(19) United States
(12) Patent Application Publication
(10) Pub. No.: US 2007/0115774 A1
(43) Pub. Date: May 24, 2007

(54) Information recording method and an information recording apparatus

(76) Inventor: Kei Hagiwara, Kanagawa (JP)

Correspondence Address: DICKSTEIN SHAPIRO LLP, 1825 EYE STREET NW, Washington, DC, 20006-5403, US

(21) Appl. No.: 10/582,170

(22) PCT Filed: Oct. 3, 2005
(86) PCT No.: PCT/JP05/18601

§ 371 Date: Jun. 8, 2006

(30) Foreign Application Priority Data
Oct. 27, 2004 (JP) 2004-311904

(51) Int. Cl. G11B 7/12

(52) U.S. Cl. 369/47.53

(57) ABSTRACT

An information recording method and an information recording apparatus are disclosed, which are mainly applicable to a multilayer optical recording medium, recording on a layer being carried out from outer circumference to inner circumference, such as in an OTP method. The information recording method includes a step of trial writing for writing data on a trial writing area of the optical recording medium while gradually changing recording power for laser irradiation, and obtaining optimal recording power based on a reproduced signal of the data that are trial-written in advance of starting a recording operation, and a step of adjusting the obtained optimal recording power according to a recording-start position, and starting the recording operation using the adjusted optimal recording power.

### TECHNICAL FIELD

The present invention generally relates to an information recording method and an information recording apparatus, and especially relates to an information recording method of and an information recording apparatus for recording information into a recordable optical recording medium having a multilayer structure of recording layers wherein recording of a layer is performed from outer circumference to inner circumference.

### BACKGROUND ART

As for optical storage media, such as a DVD (Digital Versatile Disc), storage capacity is expandable by providing two or more recording layers, i.e., a multilayer structure. With an optical disk having the multilayer structure, recording and reproduction are carried out by adjusting the focus of a light beam of an optical pickup to each recording layer, accessing the recording layers from one side. Thereby, mass recording and reproduction can be performed without turning the optical disk over. Although read-only (ROM) two-layer DVD disks for reproduction have been widely used for some time, recently and continuing, recordable DVD+R DL (Double Layer) disks having storage capacity equivalent to the ROM two-layer DVD disks are being put into practical use.

According to Patent Reference 1, a recording/reproducing apparatus and a method thereof are proposed concerning the optical recording medium having the multilayer structure, such as DVD+R DL, wherein an optimal recording power value is obtained by trial writing on a data area that belongs to the same layer (target recording layer) as a data area on which the information is to be written.

[Patent reference 1] JPA 2000-311346

### DESCRIPTION OF THE INVENTION

### Problem(s) to be Solved by the Invention

As for the format of DVD+R DL disks, a recording format called opposite track path OTP is used. According to the OTP method, as for a first recording layer Layer0 (recording layer closest to an irradiating laser), the spiral direction goes from the inner circumference to the outer circumference as usual; and as for a second recording layer Layer1, the spiral direction goes from the outer circumference to the inner circumference. Accordingly, recording/reproduction operations of the second recording layer Layer1 are performed in the direction opposite to the first recording layer Layer0.

For this reason, even if an OPC (Optimum

Power Control) operation is performed as proposed by, e.g., Patent Reference 1, wherein a trial writing process is performed to carry out trial writing on an area located at the inner circumference (Inner Disc Test Zone) of the recording layer to be used, since recording on the second recording layer starts from the outer circumference, recording quality may be degraded due to the difference in the optimal recording power of the optical disk between the inner circumference and the outer circumference.

Furthermore, in the multilayer disk, film properties of the outer circumference tend to be different from the inner circumference, which tendency is greater with the multilayer disk than a single-layer disk. Further, the tendency is greater with the second recording layer Layer1 than the first recording layer Layer0; generally, the recording power of the outer circumference is required to be greater than the inner circumference. The power requirement changes with, e.g., a change of laser luminescence due to the birefringence (double refraction) of the optical disk, an astigmatic influence of the optical pickup, and curvature (tilt) of the optical disk. Further, the power requirement changes also with kinds of optical disks and drives (optical pickup).

### DISCLOSURE OF THE INVENTION

It is a general object of the present invention to provide an information recording apparatus and a method thereof that substantially obviate one or more of the problems caused by the limitations and disadvantages of the related art.

A specific object of the present invention is to provide an information recording apparatus and a method thereof for providing high recording quality from a recording-start position when a multilayer optical recording medium is used, wherein recording is performed from the outer circumference toward the inner circumference such as with the OTP method.

Features and advantages of the present invention are set forth in the description that follows, and in part will become apparent from the description and the accompanying drawings, or may be learned by practice of the invention according to the teachings provided in the description. Objects as well as other features and advantages of the present invention will be realized and attained by an information recording apparatus and a method thereof particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides as follows.

An aspect (first aspect) of the present invention provides an information recording method, wherein a laser beam is irradiated onto a multilayer optical recording medium, the information recording method including:

a trial writing process of carrying out trial writing of data with recording power for irradiating the laser beam onto a trial writing area of the optical recording medium being gradually changed in steps, and obtaining optimal recording power based on a reproduced signal of the recorded data, the trial writing process being performed prior to actual information recording; and

a recording power adjustment process of starting a recording operation using optimal recording power that is the obtained optimal recording power as adjusted for a recording-start position.

Another aspect (second aspect) of the present invention provides the information recording method as described concerning the first aspect, wherein:

the trial writing process performs trial writing on a trial writing area located in the inner circumference of a recording layer that is to serve as the information recording layer (target recording layer) of the multilayer optical recording medium; and

the recording power adjustment process adjusts the obtained optimal recording power for the recording-start position when recording from the outer circumference to the inner circumference of the target recording layer.

Another aspect (third aspect) of the present invention provides the information recording method as described concerning the second aspect, further including:

a running trial writing process of obtaining the optimal recording power based on the signal reproduced from the data written by trial writing while the data recording operation continues; wherein the recording power adjustment process adjusts the obtained optimal recording power so that the recording power after starting the data recording operation is obtained, the optimal recording power being obtained by the running trial writing process.

Another aspect (fourth aspect) of the present invention provides the information recording method as described concerning the second and the third aspects, wherein an amount of adjustment (adjustment amount) of the recording power adjustment process is changed according to the recording-start position.

Another aspect (fifth aspect) of the present invention provides the information recording method as described concerning the fourth aspect, wherein the recording power adjustment process sets the adjustment amount based on a linear approximation corresponding to a radial position of the recording-start position of the optical recording medium.

Another aspect (sixth aspect) of the present invention provides the information recording method as described concerning the fourth aspect, wherein the recording power adjustment process adjusts the optimal recording power only when the recording-start position is located at a radial position greater than a predetermined radial position of the optical recording medium.

Another aspect (seventh aspect) of the present invention provides the information recording method as described concerning the first aspect through the sixth aspect, wherein the recording power adjustment process changes the adjustment amount of the recording power according to kinds of the optical recording medium.

Another aspect (eighth aspect) of the present invention provides the information recording method as described concerning the first aspect through the seventh aspect, wherein the recording power adjustment process adjusts the adjustment amount of the recording power with reference to the adjustment amount of the recording power beforehand stored in a non-volatile memory when an information recording apparatus is manufactured.

Another aspect (ninth aspect) of the present invention provides the information recording method as described concerning the first aspect, wherein

the trial writing process performs trial writing on the trial writing area located at the inner circumference of the target recording layer of the optical recording medium and on another trial writing area located at the outer circumference, and obtains optimal recording power of each trial writing area, and

the recording power adjustment process adjusts the optimal recording power obtained from the trial writing area of the inner circumference with reference to the optimal recording power obtained from the trial writing area of the outer circumference according to the recording-start position when recording from the outer circumference to the inner circumference of the target recording layer.

Another aspect (tenth aspect) of the present invention provides the information recording method as described concerning the ninth aspect, wherein the recording power adjustment process obtains the adjustment amount according to the radial position of recording start on the optical recording medium based on a linear approximation using the optimal recording power obtained from the trial writing area of the inner circumference and the optimal recording power obtained from the trial writing area of the outer circumference.

Another aspect (11th aspect) of the present invention provides the information recording method as described concerning the ninth aspect, wherein

the recording power adjustment process adjusts the optimal recording power based on a difference between

the optimal recording power obtained from the trial writing area of the outer circumference and

the optimal recording power obtained from the trial writing area of the inner circumference, only when the recording-start position is at a radial position greater than a predetermined radial position of the optical recording medium.

Another aspect (12th aspect) of the present invention provides the information recording method as described concerning the ninth aspect, wherein the trial writing process performs trial writing only on the trial writing area located in the outer circumference of the target recording layer of the optical recording medium, and the optimal recording power is obtained when the recording-start position is at an outermost circumferential position; and the recording power adjustment process starts recording using the optimal recording power obtained at the trial writing process.

Another aspect (13th aspect) of the present invention provides the information recording method as described concerning the first aspect through the 12th aspect, wherein the multilayer optical recording medium having two or more recording layers is recorded by the opposite track path (OTP) method based on the DVD+R specification; and the trial writing process and the recording power adjustment process are performed when recording is carried out from the outer circumference to the inner circumference of the target recording layer of the optical recording medium.

Another aspect (14th aspect) of the present invention provides an information recording apparatus wherein at least any one of the processes described concerning the first through the 13th aspects of the present invention is carried out.

### EFFECT OF THE INVENTION

Since, according to the information recording method and the information recording apparatus of the present invention, recording is carried out with power that is obtained by adjusting the optimal recording power determined by trial writing, even when recording starts from a position that is apart from the trial writing area, high-quality recording is obtained from the starting position.

Since, according to the information recording method and the information recording apparatus of the present invention, the optimal recording power obtained by trial writing to the trial writing area of the inner circumference is adjusted according to the recording-start position, and recording is started using the adjusted optimal recording power, even when recording starts from the outer circumference, which is distant from the trial writing area of the inner circumference, high-quality recording is obtained from the recording-start position.

Since, according to the information recording method and the information recording apparatus of the present invention, the recording power is adjusted to the optimal recording power obtained by the running trial writing process, high-quality recording by the optimal recording power adapting to changes in properties of the optical recording medium is obtained.

Since, according to the information recording method and the information recording apparatus of the present invention, the adjustment amount is made variable, even when recording is started from any desired middle point of a recording layer, such as when carrying out a postscript (additional writing), the amount is adjusted according to the recording-start position, high-quality recording is obtained from the recording-start position.

Since, according to the information recording method and the information recording apparatus of the present invention, the adjustment amount that is variable is obtained based on the linear approximation according to the radius position of the recording-start position of the optical recording medium, recording power can be optimized according to the recording-start position, and high-quality recording is obtained from the recording-start position.

Since, according to the information recording method and the information recording apparatus of the present invention, the adjustment of the recording power is performed only when recording is to start from a radial position that is greater than a predetermined radial position, high-quality recording is obtained while avoiding unnecessary recording power adjustment.

Since, according to the information recording method and the information recording apparatus of the present invention, the recording power adjustment takes the kinds of optical recording media, such as manufacturers and models, into consideration, optimal recording power according to the kind of the optical recording medium is used, and high-quality recording is obtained from the recording-start position.

Since, according to the information recording method and the information recording apparatus of the present invention, the adjustment amount of the recording power at the recording-start position is stored in the non-volatile memory of each information recording apparatus at the manufacturing stage, and the adjustment amount of the recording power is determined with reference to the non-volatile memory, variations from information recording apparatus to information recording apparatus can be compensated for, and high-quality recording can be obtained.

Since, according to the information recording method and the information recording apparatus of the present invention, trial writing is carried out on the trial writing area of the inner circumference and the trial writing area of the outer circumference of the target recording layer, optimal recording power of each area is obtained, and the optimal recording power obtained from the inner circumference is adjusted for a desired recording-start position with reference to the optimal recording power obtained from the trial writing area of the outer circumference; even when recording is to start from an outer circumference position that is distant from the trial writing area of the inner circumference, high-quality recording is obtained from the recording-start position.

Since, according to the information recording method and the information recording apparatus of the present invention, linear approximation using the optimal recording power obtained from the trial writing area of the inner circumference and the optimal recording power obtained from the trial writing area of the outer circumference is applied to the adjustment amount of the recording power of a given starting position expressed by a radial position of the optical recording medium, recording power for the given starting position is optimized, and high-quality recording is obtained from the given starting position.

Since, according to the information recording method and the information recording apparatus of the present invention, the optimal recording power of the given starting position is adjusted using the difference between the optimal recording power obtained from the trial writing area of the inner circumference, and the optimal recording power obtained from the trial writing area of the outer circumference only when the recording-start position is at a radial position greater than a predetermined radial position of the optical recording medium, high-quality recording is obtained from the given recording-start position, while avoiding unnecessary recording power adjustment.

Since, according to the information recording method and the information recording apparatus of the present invention, trial writing is performed only on the trial writing area located in the outer circumference of the target recording layer of the optical recording medium when the recording-start position is the outermost circumference position, the optimal recording power is obtained, and recording is performed using the obtained optimal recording power, that is, trial writing on the trial writing area of the inner circumference is dispensed with, the time required of trial writing is shortened.

The present invention can be applied to an optical recording medium with two or more recording layers having at least one layer that is to be recorded on by the opposite track path (OTP) method, based on the DVD+R specifications.

### BRIEF DESCRIPTION OF THE DRAWINGS

FIG. 1 is an outline block diagram showing a configuration example of an optical disk recording apparatus, which is an information recording apparatus according to a first embodiment of the present invention.

FIGS. 2A, 2B and 2C are graphs for explaining a β value.

FIG. 3 gives graphs showing relations between recording power and the β value.

FIG. 4 gives graphs for explaining a running OPC method.

FIG. 5 is a flowchart showing an example of a process of the running OPC method, the process containing a waiting step.

FIG. 6A is a data diagram for explaining layout and other features of DVD+R DL in the case of PTP.

FIG. 6B is a data diagram for explaining layout and other features of DVD+R DL in the case of OTP.

FIG. 7 is a flowchart showing an example of operations control performed by a controller.

FIG. 8 is a graph showing a method of determining recording power of a desired recording-start position using linear approximation.

FIG. 9 is a flowchart showing an outline of a modification.

FIG. 10 is a graph showing a method of determining the recording power of the desired recording-start position using partial linear approximation.

FIG. 11 is a flowchart showing an example of operations control performed by the controller according to a second embodiment of the present invention.

FIG. 12 is a graph showing the method of determining the recording power of the given recording-start position using linear approximation.

FIG. 13 is a graph showing the method of determining the recording power of the given recording-start position using partial linear approximation.

### BEST MODE FOR CARRYING OUT THE INVENTION

In the following, embodiments of the present invention are described with reference to the accompanying drawings.

### First Embodiment

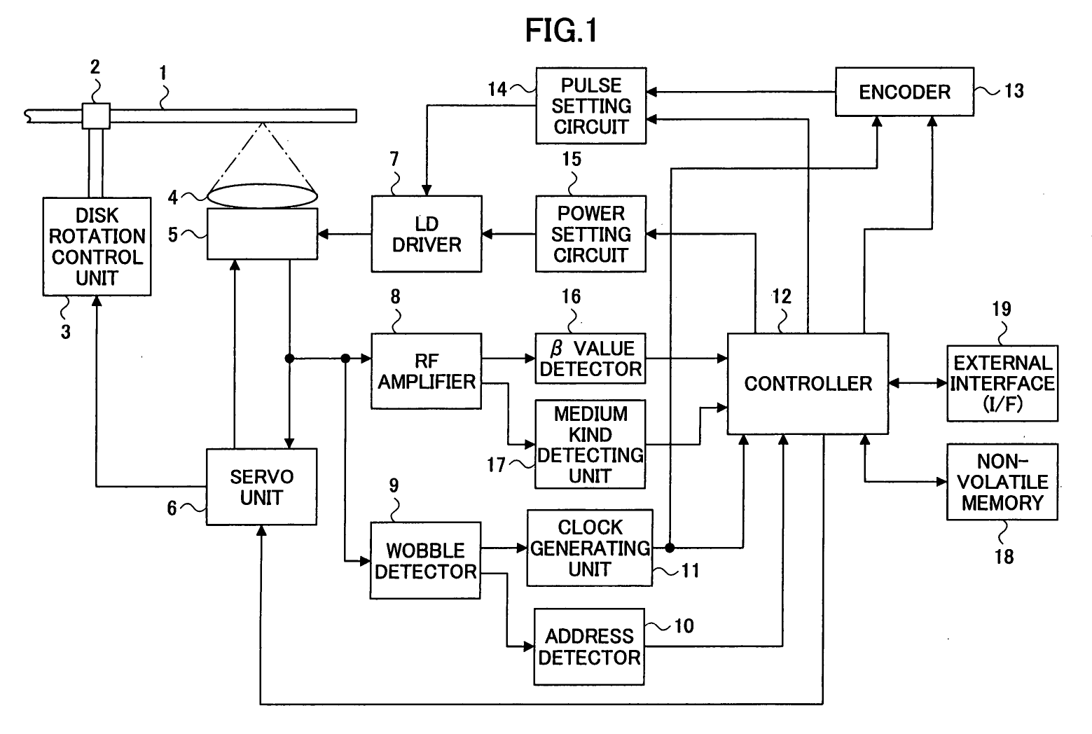

The first embodiment of the present invention is explained with reference to FIG. 1 through FIG. 10. FIG. 1 is a block diagram of an example of an optical disk recording apparatus, which is an information recording apparatus according to the first embodiment. The optical disk recording apparatus of the first embodiment is shown, for example, as applied to the case wherein an optical recording medium is a DVD+R DL (Double Layer) disk.

The optical disk recording apparatus includes

a spindle motor 2 for rotating an optical recording medium 1 that is loaded into the optical disk recording apparatus,

a disk rotation control unit 3 for controlling rotation of the spindle motor 2 to a predetermined rotational speed,

a laser light source (not shown) such as a semiconductor laser LD,

an objective lens 4,

a light-receiving element (not shown),

an optical pickup 5 for condensing and irradiating a laser beam onto the optical recording medium 1 such that recording/reproduction of information is carried out onto/from the optical recording medium 1, the optical pickup 5 being movable in the radial direction for seeking, and

a servo unit 6 connected to the optical pickup 5, the servo unit 6 performing focusing servo, tracking servo, and tilt (inclination) control such that the laser light from the optical pickup 5 is focused onto the recording film of the optical recording medium 1.

Further, since the optical pickup 5 is freely movable in the radial direction of the optical recording medium 1 by the driving of a seek motor, it can access any area of the optical recording medium 1, such as a predetermined trial writing area (Inner disc test zone) and a predetermined user data area. Further, an LD driver 7 is connected to the laser light source, for example, a semiconductor laser LD, in the optical pickup 5. With this configuration, the semiconductor laser LD is modulated by an input pulse signal such that the laser light is irradiated at a predetermined recording power level, being driven by the LD driver 7. That is, the semiconductor laser LD is modulated between a recording power state and a space power state, the recording power state forming a recording mark on the recording film. The recording mark is a pit (hole) in the case of an irreversible organic coloring-matter medium such as a DVD+R disk; and where there is no pit, it is called a space. When recorded information is reproduced, since the reflection factor of the pit (mark) differs from the reflection factor of the space, the recorded information can be reproduced.

The optical disk recording apparatus further includes

an RF amplifier 8 for reproducing the information signal RF recorded in the optical recording medium 1, the RF amplifier 8 being connected to the output side of the light-receiving element of the optical pickup 5, and

a wobble detector 9 for detecting a meandering (wobble) signal beforehand recorded on a recording slot (groove) of the optical recording medium 1, such as the DVD+R disk in the embodiment, the wobble signal serving as position (address) information within the disk, and the like, obtained prior to data recording, the wobble detector 9 being connected to the output side of the light-receiving element of the optical pickup 5. Here, as a modulation technique of the wobble signal, for example, a frequency-modulation method can be used for a CD-R/RW disk, and a phase modulation method can be used for a DVD+R/RW disk. An address detector 10 and a clock generating unit 11 are connected to the wobble detector 9. The address detector 10 recovers the address information called ADIP (ADdress In Pre-groove) from the wobble signal detected by the wobble detector 9. Based on the address information, the optical pickup 5 is moved to a desired position of the optical recording medium 1, and recording/reproducing is performed. In addition, the physical address of a DVD is generally called PSN (Physical Sector Number), and the address is hereafter called PSN. Further, the clock generating unit 11 converts the wobble signal detected by the wobble detector 9 into a binary form, generates a clock signal that is in sync with the position on the optical recording medium 1 by a PLL (Phase Lock Loop) circuit, and supplies the clock signal to a controller 12 and an encoder 13.

The controller 12 includes a CPU, a ROM, and a RAM, and is connected to the encoder 13, a pulse setting circuit 14 and a power setting circuit 15 for the LD driver 7. The power setting circuit 15 outputs a recording power signal for driving the LD driver 7 according to instructions about the recording power provided by the controller 12. The pulse setting circuit 14 outputs a pulse signal having a pulse width according to recording data provided by the encoder 13. Then, the semiconductor laser LD in the optical pickup 5 irradiates the laser light with the power and pulse width that are set up as described above. Further, in the case of trial writing, i.e., in an OPC process, the recording power is made variable step by step as described below (trial writing mode). In this case, data for the trial writing are encoded and modulated by a predetermined format by the encoder 13, and output as a recording data stream in serial form. Although the pulse width in this case may be set to a fixed width, it is common to set different pulse widths according to linear velocity and the kind of the disk by the controller 12. This is because the difference in linear velocity and the sensitivity for every recording mark length by the kind of the disk can be compensated for.

The optical disk recording apparatus further includes a β value detector 16, and a medium kind detecting unit 17, which are connected to the output side of the RF amplifier 8, and provide respective detection results to the controller 12. The β value detector 16 is used in an evaluation process of a reproduced signal when performing the trial writing process described below. Further, the kind (manufacturer, model, etc.) of the optical recording medium 1 that is loaded is distinguished by the medium kind detecting unit 17 based on the reproduced signal provided by the RF amplifier 8, when the recording in a specific place of the optical recording medium 1 is reproduced by the optical pickup 5. As for the kind detection, if a manufacturer can be identified, the kind detection may use the disk manufacturer as the kind. If further details are available, the kind detection can also use such details. Further, various parameters are often embedded in the optical recording medium 1, and such parameters can also be used. For example, when recommended power, recommended pulse width, etc., are embedded, these may be used. In this manner, an optimal pulse width can be set up (called Write Strategy=recording strategy) corresponding to the manufacturer's various recording films. Optical disk recording apparatuses (drive equipment) often hold a table of the recording strategy optimized for various optical recording media of various manufacturers in, e.g., the non-volatile memory 18.

In addition, the optical disk recording apparatus further includes an external interface (I/F) 19 for connecting the controller 12 of the optical disk recording apparatus to a host machine, etc.

Next, general descriptions about trial writing and DVD-R DL follow.

Trial writing, often called OPC (Optimum Power Control), is an operation for determining an optimal recording power level, wherein recording is performed on a predetermined trial writing area on the optical recording medium 1 while sequentially changing the recording power irradiated from a semiconductor laser LD while rotating the optical-recording medium 1 at a certain recording linear velocity, data recorded on the trial writing area are reproduced, a recording state is determined based on the reproduced signal, and the optimal power level that produces the optimal recording state is determined. With the optical disk recording apparatus as shown in FIG. 1, trial recording is performed with the recording power being sequentially changed by the power setting circuit 15 according to instructions from the controller 12. As for the trial writing area, it is common to use a PCA (Power Calibration Area), also called Inner Disc Test Zone, that is located at a radial position less than a Lead-in area radial position. After trial recording is performed on the trial writing area PCA, the recording on the same place is reproduced by the optical pickup 5, and a reproduced signal RF is obtained. Evaluating a suitable parameter of the RF signal, the optimal recording state is determined. For example, the β value detector 16 measures a parameter β. The β value detector 16 removes low frequency components of the RF signal (AC coupling) acquired from the RF amplifier 8, and detects an upper envelope level “a” and a lower envelope level “b”.

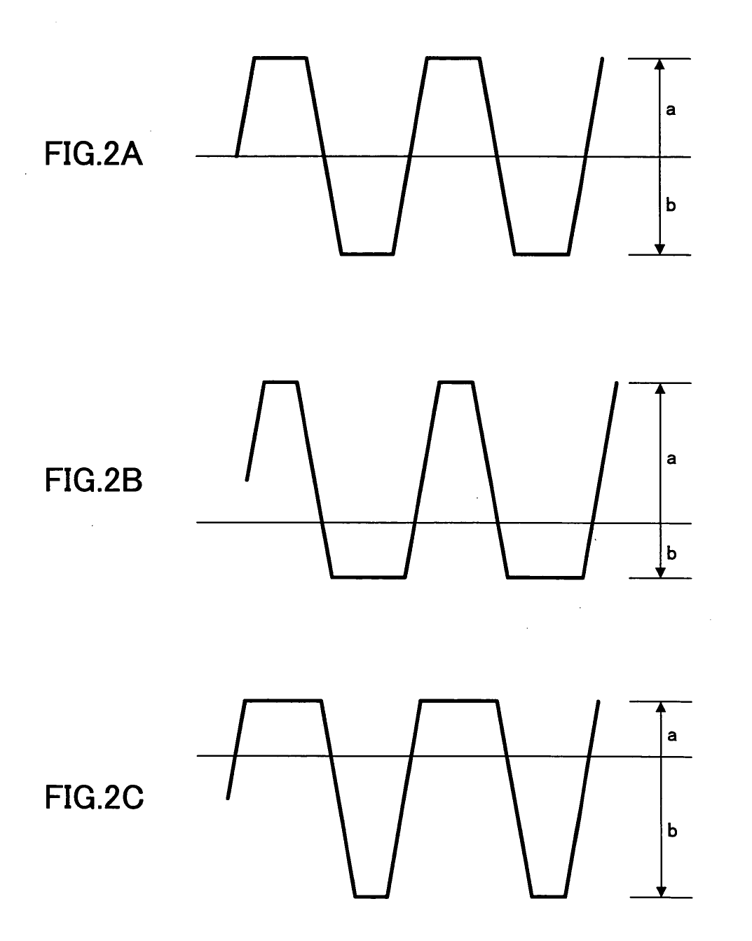

Descriptions of the β value follow with reference to FIGS. 2A, 2B, and 2C. It is assumed that the reflection factor is lower at the recording mark section than the space section as a property of the recording film of the optical recording medium 1, and that the RF level is lower at the lower reflection section. Under this assumption, when the RF signal that is AC coupled is in the proper recording state, the upper and lower sides are symmetric as shown in FIG. 2A, i.e., a=b. When the recording power is excessive, the recording mark section becomes longer as shown in FIG. 2B, and if AC coupling is carried out, the upper level becomes greater, i.e., a>b. On the contrary, when the recording power is insufficient, the recording mark section becomes shorter as shown in FIG. 2C, and if AC coupling is carried out, the lower level become greater, i.e., a<b. The β value is defined by the difference between a and b normalized by the RF amplitude a+b, namely
β=(a−b)/(a+b).

If the β value is great, the power is great, and vice versa. The optimal recording power is obtained ideally when the β value is zero; however in practice, when the β value becomes less than a certain value, for example, about 4%, the optimal recording power is considered obtained, and the β value at this time is called βtarget. OPC is to obtain the optimal recording power by sequentially changing the recording power, recording with the recording power, evaluating the β value of each recorded section, and determining a recording power level that provides the βtarget.

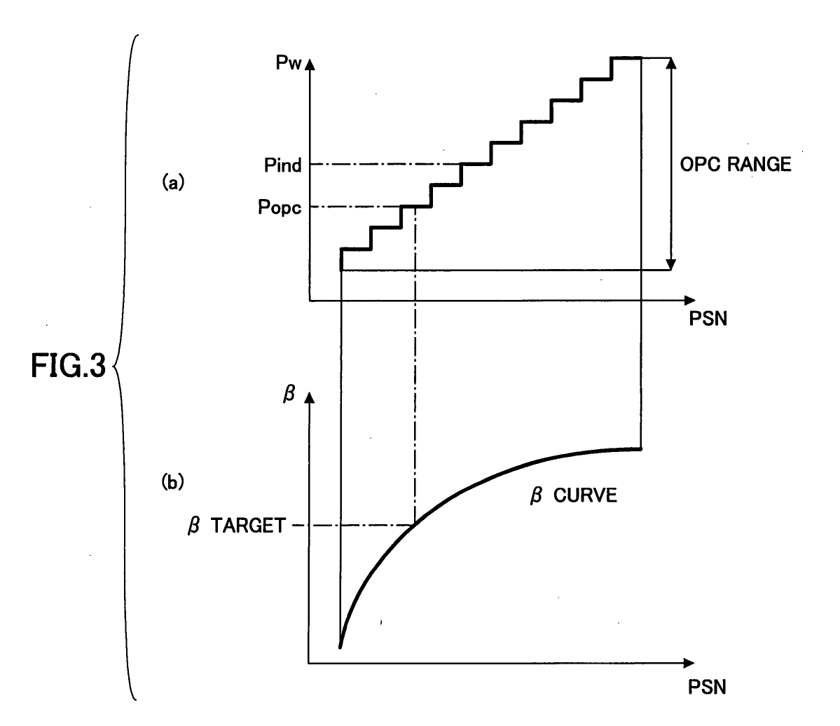

FIG. 3 is a graph showing relations between the recording power and the β value. The upper part of FIG. 3 (marked (a)) shows an example wherein trial writing is performed with the recording power that is sequentially changed in ten stages. The range of the recording power being changed is called an OPC range, and the center of the OPC range (central power) is called Pind. The OPC range can be defined, for example, as a range of +30% and −30% of the central power Pind divided by ten stages, or as a range between +5 mW and −4 mW with reference to the central power Pind divided in 1 mW steps. Anyway, β values obtained from the stages (steps), which number ten in these examples, are processed by curve approximation (quadratic approximation), and a β curve as shown in the lower part of FIG. 3 (marked (b)) is obtained; and the optimal recording power Popc corresponding to the βtarget value is obtained. Since the optimal recording power Popc somewhat fluctuates according to conditions at the time of performing OPC, such as temperature change, it is desirable that Popc be near the central power Pind as much as possible. Further, since the optimal recording power Popc may differ from optical recording medium to optical recording medium, the optimum recording power Popc is often set up with the recording strategy for each kind of optical recording medium.

Further, means is disclosed wherein the optimal recording power is adjusted while recording information according to a result of comparison between a predetermined desired value of the recording state and a value obtained from the reproduced signal provided by the optical recording medium 1. This is called running trial writing (Running OPC), in contrast to the so-called trial writing OPC (Optimum Power Control). According to the running OPC, the optimal recording power is adjusted on a real time basis while recording. By the running OPC, the optimal recording power is suitably adjusted so that changes in recording sensitivity due to changes in sensitivity of the medium under recording, wavelength variation of the light source, etc., may be reduced.

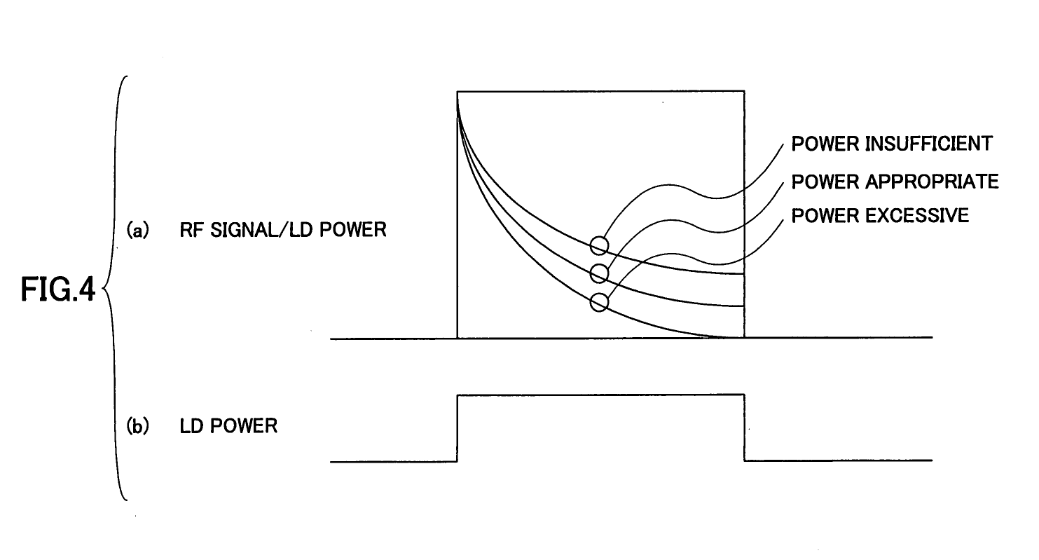

FIG. 4 is a graph for explaining the running OPC. The lower part of FIG. 4 (marked (b)) shows the shape of a recording pulse. Here, although a multi-pulse, a CASL strategy pulse, etc., are often used, a square wave (block pulse) is shown for simplicity of explanation. The upper part of FIG. 4 (marked (a)) shows the wave shape of an RF signal that is being recorded, which RF signal is normalized by the recording power (LD power). At the rising edge of the recording pulse (RF signal), the film of the optical recording medium 1 has a high reflection factor, and then, the film of the optical recording medium 1 is immediately burnt, and the reflection factor falls. The running OPC controls the optimal recording power such that a value of (RF signal)/(LD power) becomes equal to a target value.

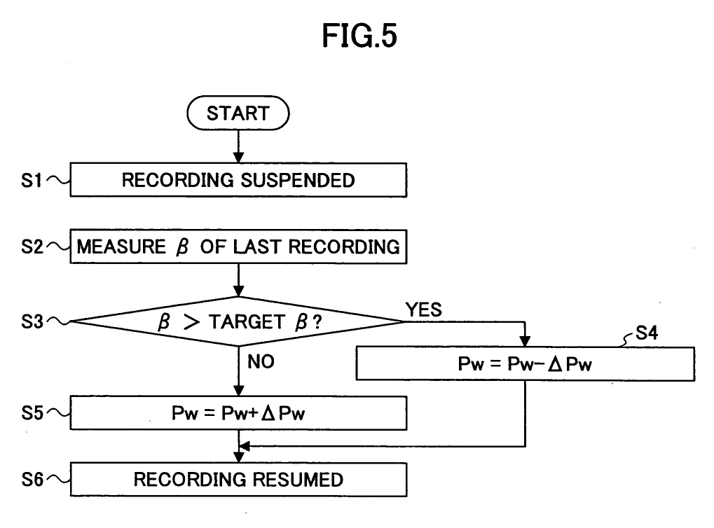

Further, with the running OPC method that controls the recording power on a real time basis, a control error is often too great. In order to cope with this problem, a method of solving the problem is known, which method is as shown by a flowchart of FIG. 5. Here, recording is first suspended (Step S1); the β value immediately before the recording suspension is measured (S2); if the measured β value is greater than a target value βtarget (Y at S3), the recording power Pw is reduced by a predetermined value ΔPw (S4); if the measured β value is not greater than the target value βtarget (N at S3), the recording power Pw is increased by the predetermined value ΔPw (S5); and the recording power is gradually adjusted followed by resumption of recording (S6).

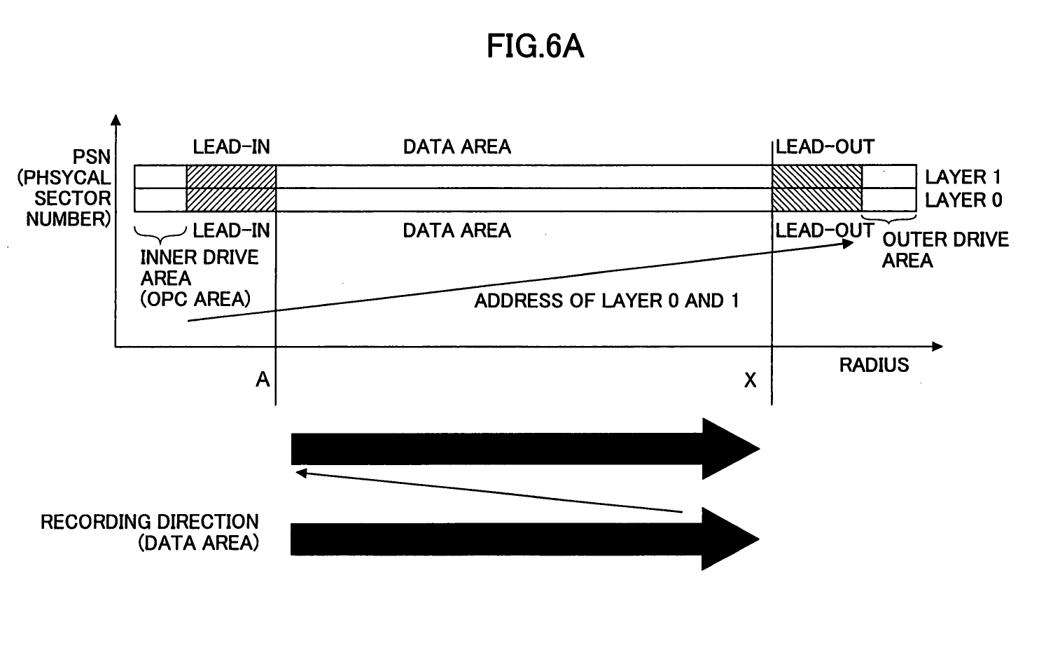

Layout, etc., of a DVD+R medium having a multilayer structure (two layers, here) of recording layers, i.e., DVD+R DL, serving as the optical recording medium 1 are described with reference to FIGS. 6A and 6B. Here, a first layer that is closer to the laser is called Layer0, and the next layer, a second layer, following the first layer is called Layer1.

FIG. 6A shows a disk having two layers (Dual Layer) on one side according to a parallel track path PTP method, which disk is called a PTP disk. FIG. 6B shows a disk having two layers on one side according to an opposite track path OTP method, which disk is called an OTP disk.

A DVD disk fundamentally has an information area that contains a lead-in area, a data area, and a lead-out area. In the case of the PTP disk, an information area is provided for each recording layer. The OTP disk has one information area, and has a middle zone at the outer circumference for each recording layer. As for Layer0 and Layer1 of the PTP disk, and Layer0 of the OTP disk, recording and reproduction of data are performed from inner circumference to outer circumference. As for Layer1 of the OTP disk, recording and reproduction of data are performed from outer circumference to inner circumference. Physical addresses (Physical Sector Number, PSN) are sequentially assigned to each recording layer of the PTP disk from the lead-in area to the lead-out area. On the other hand, in the case of the OTP disk, the physical addresses are sequentially assigned from the lead-in area to the middle zone of Layer0, and bit-reversed addresses of the physical addresses of Layer0 are assigned to Layer1, where the physical addresses increase from the middle zone to the lead-out area. That is, the starting address of the data area in Layer1 is a bit-reverse of the ending address of Layer0.

In other words, the spiral direction of the guidance slot in the case of the PTP disk, as shown in FIG. 6A, is from inner circumference to outer circumference for both Layer0 and Layer1 (i.e., the optical pickup 5 moves from inside to outside). In the case of the OTP disk, the spiral direction of Layer0 is the same as the PTP disk, but the spiral direction of Layer1 is from outside to inside (the optical pickup 5 moves from outside to inside). Out of the two methods, namely, PTP and OTP, the OTP method is used by the recordable DVD+R DL disk. According to the OTP method, the lead-in area is provided at the inner circumference of Layer0, and the lead-out area is provided at the inner circumference of Layer1; and each of Layer0 and Layer1 has a middle zone at the outer circumference. The middle zones serve as buffer zones that are prepared to avoid a possible problem that may arise when accessing the boundary section where data may be suddenly lost at the edge of the data area. The PCA area for performing OPC is provided at an inner drive area (OPC area) that is the innermost circumference, at a radius less than the radius of the lead-in area.

As described, in the case of the OTP method, recording on the first recording layer Layer0 is performed from the inner circumference to the outer circumference like the conventional DVD+R, etc. However, recording on the second recording layer Layer1 is performed from the outer circumference to the inner circumference. For this reason, when recording starts at the outermost periphery, the optimal recording power determined by OPC with reference to the inner circumference may not be adequate. Generally, recording power required at the outer circumference tends to be greater than the inner circumference, and recording power is often increased. Especially, in the case of a two-layer disk like the DVD+R DL disk, it is difficult to make the film thickness uniform over the whole layer surface, from the inner circumference to the outermost circumference, compared with a single-layer disk. This is especially remarkable in the second recording layer Layer1, and, generally, the recording power at the outermost circumference position is required to be higher than the inner circumference. It is considered that a change of laser luminescence due to birefringence of the medium, an astigmatic influence of the optical pickup, and a curvature (tilt) of the medium, etc., serve as the factors.

In consideration of the discussion above, the information recording method and the information recording apparatus of the embodiment are configured such that

the optimal recording power is determined based on the reproduced signal of the data written by trial writing carried out with the recording power irradiated to the trial writing area PCA of the inner circumference of the optical recording medium 1 gradually changing in advance of the recording operation start of actual data; and

the optimal recording power is adjusted according to the recording-start position before starting recording.

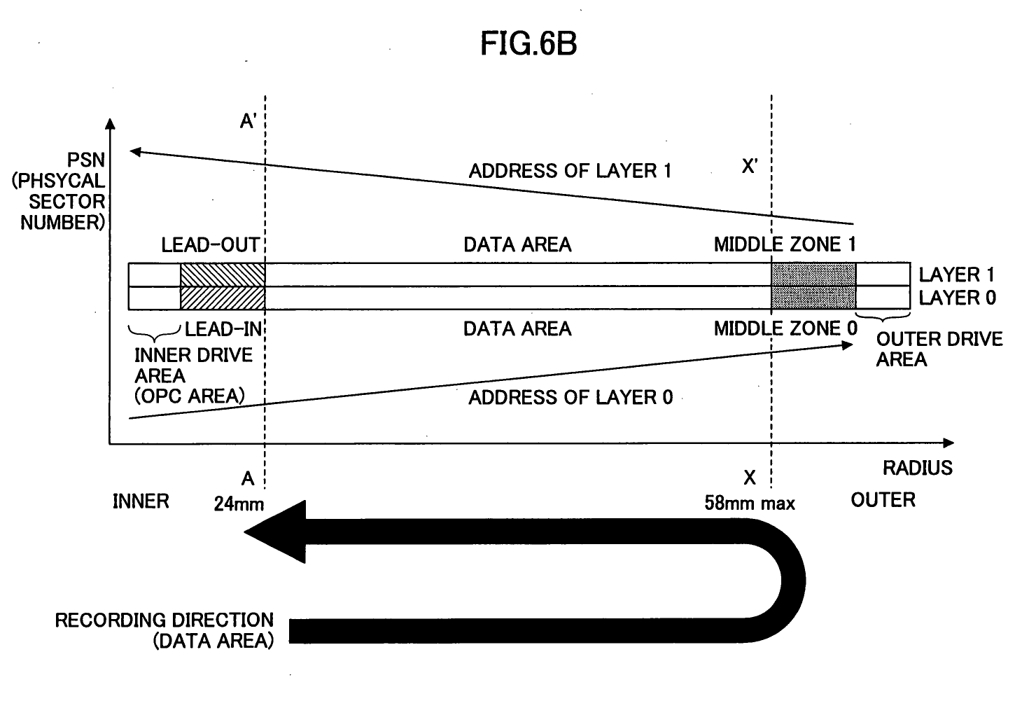

FIG. 7 is a flowchart showing an example of operations control performed by the controller 12. First, when the optical recording medium 1 is loaded for recording operations, information about the recording-start position from which the recording operation is to start is acquired (S11). Then, the optimal recording power is determined based on the reproduced signal RF of the data written by trial writing, and its β value, wherein the trial writing area PCA of the inner circumference of the recording layer is accessed, the PCA holding the trial writing data recorded with the recording power being gradually changed; and the optimal recording power is adjusted according to the recording-start position (inner circumference OPC execution) (S12). Step S12 serves as a trial writing process and trial writing means.

After the trial writing process, it is determined whether the recording layer concerned (target recording layer) is the second recording layer Layer1 (S13). If it is not the second recording layer Layer1 (N at S13), the target recording layer is determined to be the first recording layer Layer0, the recording direction of which is from inner circumference to outer circumference, and recording operation is started from the recording-start position of the data area using the optimal recording power obtained by the OPC process (S15). Otherwise, if the target recording layer is determined to be the second recording layer Layer1 (Y at S13), the recording direction of which is from outer circumference to inner circumference, the optimal recording power obtained by the OPC process is adjusted (S14). Here, the adjustment is carried out such that the optimal recording power obtained by the OPC process is incremented by a predetermined amount. Then, the recording operation is started from the outermost periphery position and runs to the inner circumference of the data area of the second recording layer Layer1 using the adjusted optimal recording power (S15). The steps S14 and S15 serve as a recording power adjustment process and recording power adjustment means. In this way, even when recording is performed from the outermost periphery that is distant from the trial writing area PCA of the inner circumference of the second recording layer Layer1, the recording operation provides high-quality recording from the recording-start position.

After the recording operation starts, the running OPC process described above is performed (S16), and the recording operation continues with the optimal recording power as determined by the running OPC process, wherein the recording power for irradiating the laser LD onto the optical recording medium 1 is continuously adjusted (S17 and N at S18). In this way, high-quality recording is maintained by gradually adjusting the optimal recording power according to variations of the optical recording medium 1. Step S16 serves as a running trial writing process and running trial writing means. Here, the running trial writing process may determine the optimal recording power by one of the two methods, namely, the method of determining the optimal recording power on a real time basis while performing the recording operation, and the method of determining the optimal recording power by first suspending the recording operation as described above as shown in FIG. 5.

In the case where recording starts from the outermost periphery position of the data area of the second recording layer Layer1 and runs to the inner circumference, the process as described above is sufficient. However, there are cases where recording starts from a middle position of the data area of the second recording layer Layer1, such as the case where data that would not fully use the disk capacity are written by write-at-once, and the case where a postscript is added without closing a session. When recording is to start from the middle position, since the adjustment amount of the optimal recording power obtained from the trial writing area PCA of the inner circumference is small compared with the case where recording starts from the outermost periphery position, a different adjustment amount is used at Step S14. Namely, the adjustment amount of the recording power is determined according to the radial position of the recording start position.

In this case, the recording power after starting recording may be controlled by the running OPC described above; or alternatively, the power control may be performed according to a predetermined power profile for different radial positions.

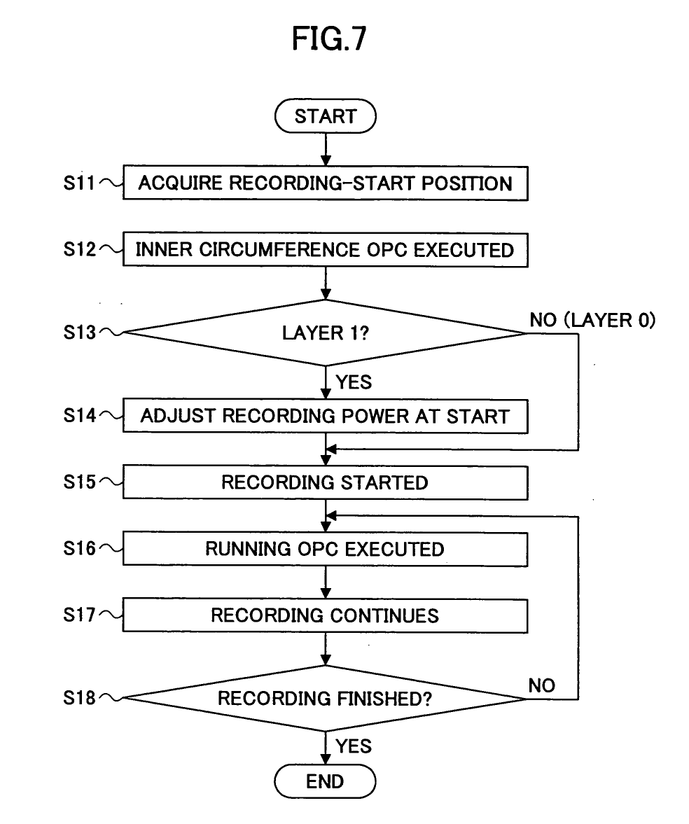

As the adjustment method of the recording power at the recording-start position, there is a method of carrying out a linear approximation with reference to the radial position of the recording-start position. FIG. 8 is a graph for explaining how the recording power at the recording-start position is determined according to the linear approximation. In FIG. 8, Rin represents the radial position of the innermost circumference, Rout represents the radial position of the outermost circumference, r represents the radial position of the recording-start position, Popc is the optimal recording power obtained by the OPC process carried out on the trial writing area PCA at the inner circumference, dPw(r) represents an adjustment amount of the recording power according to the radial position, and dPw0 represents the adjustment amount of the recording power at the outermost circumference radial position according to the predetermined power profile. Then, the recording power Pw(r) according to the radial position r at which recording is to start is expressed as Pw(r)=Popc+dPw(r), which can be linearly approximated as follows.
Pw(r)=Popc+dPw0/(Rout−Rin)*r

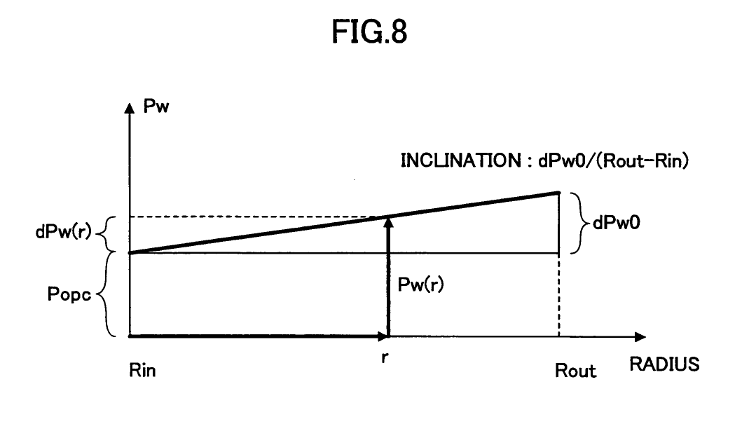

However, in fact, the adjustment as described above is usually required only when recording on an area in the outer circumference. Taking this into consideration, it is determined whether the radius position r of recording-start is located at a radial position greater than a predetermined radial position R1 as shown in FIG. 9 (S19); if r is less than the predetermined radial position R1 (N at S19), recording is started using the optimal recording power obtained by the OPC processing (S15); and if r is equal to or greater than the predetermined radial position R1 (Y at S19), the adjustment process is performed on the optimal recording power that is obtained by the OPC process (S14), and then recording is started. In this way, high-quality record quality is obtained from any desired recording-start position, avoiding unnecessary recording power adjustment.

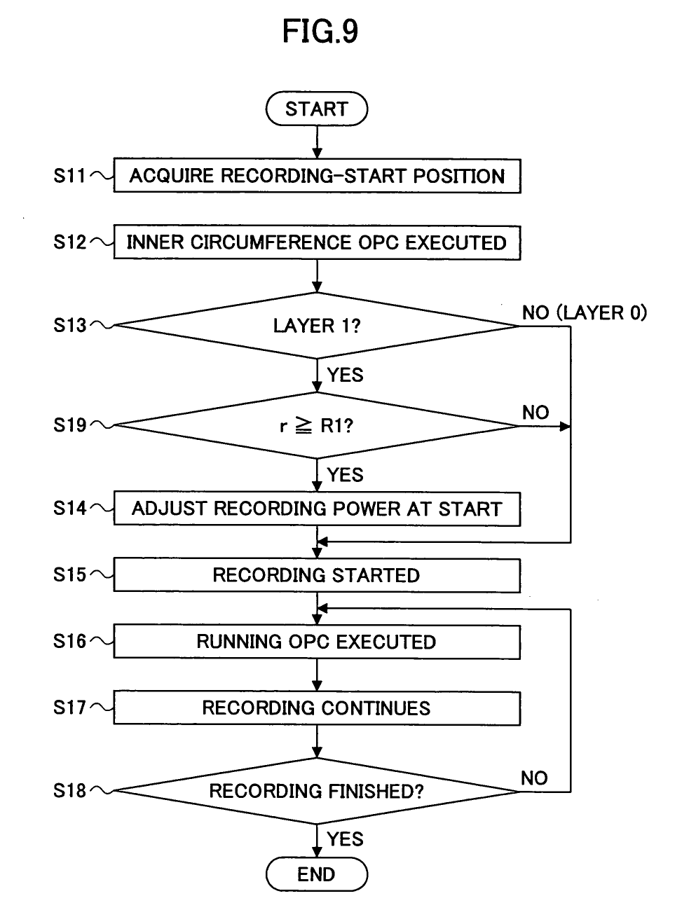

FIG. 10 is a graph explaining the case described above where the recording power at the recording-start position is obtained according to partial linear approximation. Namely, if R1 with reference to FIG. 10 is set to 42 mm,

$$\begin{matrix}Pw ( r ) = Popc + dPw ( r ) \\ dPw ( r ) = 0 ( if r < 42 mm ) \\ = ( dPw 0 / ( Rout - R 1 ) ) * ( r - R 1 ) ( if r >= 42 mm )\end{matrix}$$

Further, the optimal value (the predetermined power profile) of the adjustment amount of the recording power may change with the kind of media (a disk manufacturer, disk kind, etc.). Then, the optimal value (the predetermined power profile) of the adjustment amount of the recording power is beforehand stored as one of tables of a recording strategy according to the medium kind. Then, at the time of recording, the kind of the optical recording medium 1 that is loaded is distinguished by the medium kind detecting unit 17, and the optimal value (the predetermined power profile) of the adjustment amount of the recording power according to the medium kind is obtained by referring to the table of the recording strategy at Step S14. According to the kind of the optical recording medium 1, the adjustment amount of the recording power is determined. In this way, high-quality recording is obtained by the optimal recording power according to the kind of the optical recording medium 1.

Further, the optimal value (the predetermined power profile) of the adjustment amount of the recording power is subjected to variations of each optical disk recording apparatus, mainly depending on variations of the optical pickup 5. Then, each optical disk recording apparatus is adjusted in the manufacture stage, and the parameter of the optimal value (the predetermined power profile) of the adjustment amount of the recording power using the adjustment result of the optical disk recording apparatus is stored to the non-volatile memory 18. When recording, the optimal value (the predetermined power profile) of the adjustment amount of the recording power for the optical disk recording apparatus concerned stored in the non-volatile memory 18 is used at the time of recording power adjustment at Step S14. In this way, the variations among optical disk recording apparatuses can be compensated for, and high-quality recording is obtained.

### The Second Embodiment

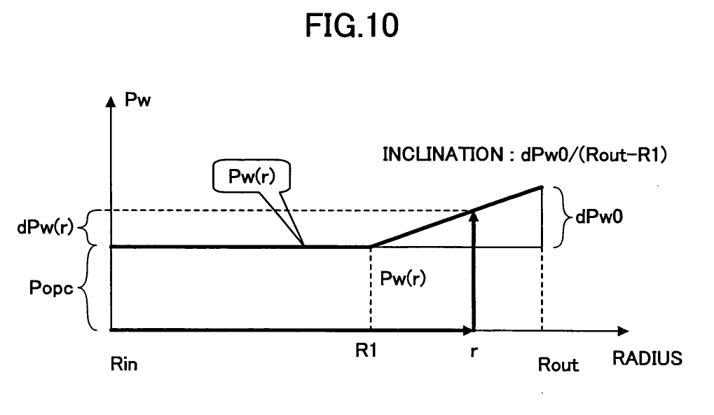

Next, the second embodiment of the present invention is described with reference to FIG. 11 through FIG. 13. The same portions as the portions described in the first embodiment are shown by the same reference numbers, and explanations thereof are not repeated. Although the second embodiment is basically the same as the first embodiment, a difference, for example, is that a PCA (a power calibration area) is provided at an outer disc test zone that is located outside of the middle zone in addition to the PCA in the inner disc test zone in the inner circumference (refer to FIG. 6B). In this way, the adjustment amount of the required optimal recording power between inside-and-outside circumferences is obtained by actual measurement.

FIG. 11 is a flowchart showing an example of operations control performed by the controller 12 according to the second embodiment. First, when the optical recording medium 1 is loaded for recording, information about the recording-start position is acquired (S21). Then, the process of obtaining the optimal recording power is performed based on the reproduced signal RF and its β value of the data written by trial writing, accessing the trial writing area PCA of the inner circumference of the target recording layer, and gradually changing the recording power (inner circumference OPC) (S22). Further, a process of obtaining the optimal recording power is performed based on the reproduced signal RF and its β value of the data written by trial writing accessing the trial writing area PCA of the outer circumference of the target recording layer, and gradually changing the recording power concerned (outer circumference OPC) (S23). Steps S22 and S23 serve as the trial writing process and the trial writing means.

After the trial writing process, it is determined whether the target recording layer is the second recording layer Layer1 (S24). If it is not the second recording layer Layer1 (N at S24), since it is the first recording layer Layer0, and the recording direction is from the inner circumference to the outer circumference, recording is started from the recording-start position of the data area using the optimal recording power obtained by the inner circumference OPC process (S26). Otherwise, the target recording layer is determined to be the second recording layer Layer1 wherein recording goes from the outer circumference to the inner circumference (Y at S24), and the optimal recording power obtained by the inner circumference OPC process is adjusted with reference to the optimal recording power obtained by the outer circumference OPC process (S25). Details of Step S25 are presented below. Then, recording is started from the recording-start position in the data area of the second recording layer Layer1 and runs to the inner circumference using the adjusted optimal recording power (S26). Steps S25 and S26 serve as the recording power adjustment process and the recording power adjustment means.

Once recording is started, the running OPC process as described above is performed (S27), and recording is continued with the recording power for irradiating the laser beam LD onto the optical recording medium 1 being adjusted by the running OPC process to the optimal recording power (S28 and N at S29). In this way, after recording is started, high-quality recording is obtained by adjusting the optimal recording power responding to a change in the optical recording medium. Step S27 serves as the running trial writing process and the running trial writing processing means. Step 27 may adopt either of the methods, namely, the method of obtaining the optimal recording power by the running trial writing process while recording the data, or the method wherein data recording is first stopped for obtaining the optimal recording power as shown in FIG. 5.

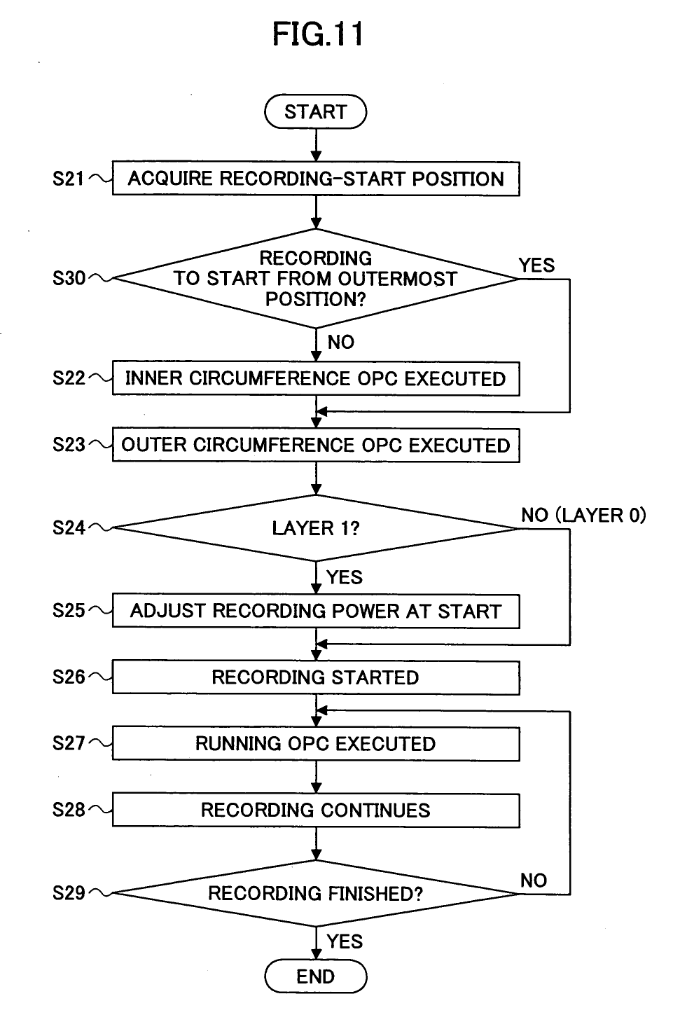

As for the method of adjusting the recording power at the recording-start position determined at Step S25, a linear approximation with reference to the radial position of the recording-start position can be used. FIG. 12 is a graph for obtaining the recording power at the recording-start position according to the linear approximation. In FIG. 12, Rin represents the radial position of the innermost circumference, Rout represents the radial position of the outermost circumference, r represents a radial position of the recording-start position, Popc(inner circumference) is the optimal recording power obtained by the OPC process carried out on the trial writing area PCA of the inner circumference, Popc(outer circumference) is the optimal recording power obtained by the OPC process carried out on the trial writing area PCA of the outer circumference, dpw(r) represents the adjustment amount of the recording power according to the radial position, and dPw0 represents the adjustment amount of the recording power required of the outermost circumference radial position. Then, the recording power Pw(r) of the radial position r the recording-start position is equal to

Popc(inner circumference)+dPw(r), which can be approximated by

$$\begin{matrix}Pw ( r ) = Popc ( inner circumference ) + \\ \{ \begin{matrix}Popc ( outer circumference ) - \\ Popc ( inner circumference )\end{matrix} \} / ( Rout - Rin ) * r \\ = Popc ( inner circumference ) + dPw 0 / ( Rout - Rin ) * r\end{matrix}$$

However, in fact, the adjustment process of the recording power is usually required only when recording is performed on an area relatively close to the outer circumference. In view of this, as shown by the flowchart of FIG. 9, it is determined whether the radial position r, from which recording is to start, is located at a radial position greater than the predetermined radial position R1. If r is determined to be less than the predetermined radial position R1, recording is carried out using the optimal recording power obtained by the inner circumference OPC process. Otherwise, if r is equal to or greater than R1, recording is carried out using the optimal recording power obtained by the inner circumference OPC process as adjusted with reference to the optimal recording power obtained by the outer circumference OPC process. In this way, high-quality recording is obtained from any desired recording-start position, avoiding unnecessary recording power adjustment.

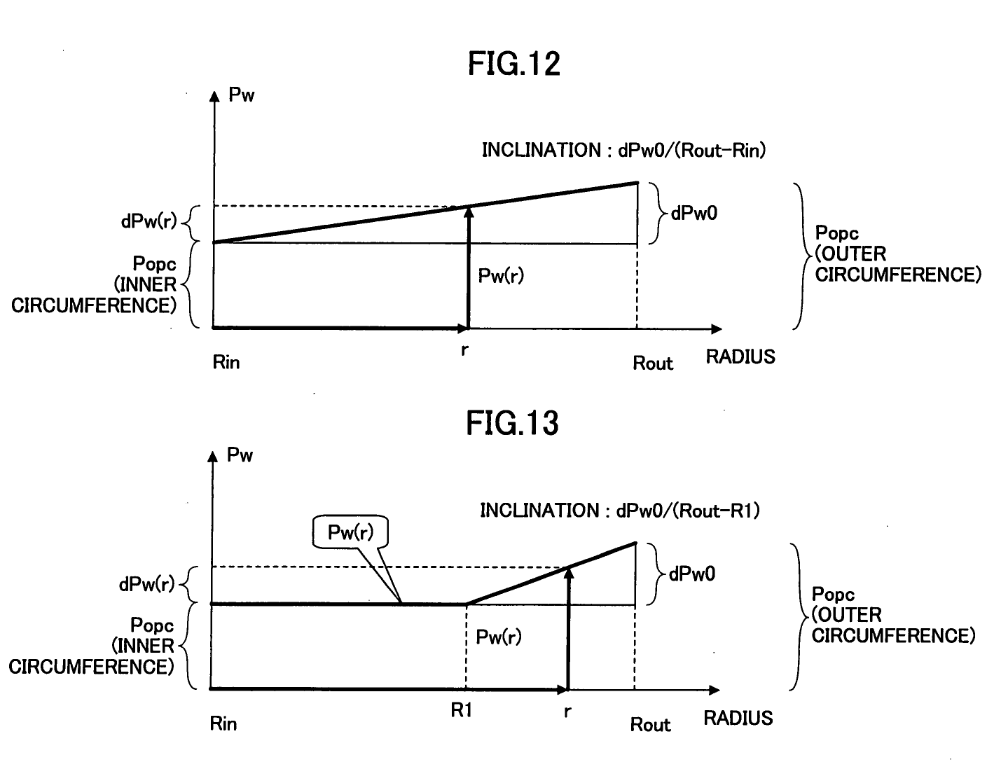

FIG. 13 is a graph for obtaining the recording power at the recording-start position according to the partial linear approximation as described above. That is,

$$\begin{matrix}Pw ( r ) = Popc ( inner circumference ) + dPw ( r ) \\ dPw ( r ) = 0 ( if r < R 1 ) \\ = ( \{ \begin{matrix}Popc ( outer circumference ) - \\ Popc ( inner circumference )\end{matrix} \} / ( Rout - R 1 ) ) * ( r - R 1 )\end{matrix}$$

Further, if the recording-start position is the outermost circumference position of the data area of the second recording layer Layer1 (Y at S30), the inner circumference OPC process of Step S22 is not performed, but only the outer circumference OPC process of Step S23 is performed. The recording power is set up using the optimal recording power obtained by the outer circumference OPC process at the recording-start power setting process of Step S25, and recording is started (S26). In this case, the recording-start position and the OPC process position are adjacent to each other; accordingly the optimal recording power obtained as it is can be used as recording-start power, and trial writing at the inner circumference is dispensed with, shortening the time required of the recording power adjustment process.

Further, the present invention is not limited to these embodiments, but variations and modifications may be made without departing from the scope of the present invention.

The present application is based on Japanese Priority Application No. 2004-311904 filed on Oct. 27, 2004 with the Japanese Patent Office, the entire contents of which are hereby incorporated by reference.

1. An information recording method of recording information by irradiating a laser beam onto a multilayer optical recording medium, comprising:
a trial writing process of performing trial writing of data on a trial writing area of the optical recording medium with recording power of the laser beam being gradually changed, and obtaining optimal recording power based on a reproduced signal of the data that are trial-written in advance of a recording operation start; and
a recording power adjustment process of adjusting the optimal recording power according to a recording-start position, and starting the recording operation using the adjusted optimal recording power.

2. The information recording method as claimed in claim 1, wherein
the trial writing area on which the trial writing process is performed is located at an inner circumference of a target recording layer of the optical recording medium, and
the recording power adjustment process adjusts the optimal recording power according to the recording-start position when recording on the target recording layer that should be recorded on from an outer circumference to the inner circumference.

3. The information recording method as claimed in claim 2, further comprising:
a running trial writing process of obtaining the optimal recording power based on the reproduced signal of the data that are trial-written during the recording operation, wherein
the recording power adjustment process adjusts the recording power after starting the recording operation to the optimal recording power obtained by the running trial writing process.

4. The information recording method as claimed in claim 2, wherein the recording power adjustment process adjusts the adjustment amount according to the recording-start position.

5. The information recording method as claimed in claim 4, wherein the recording power adjustment process adjusts the adjustment amount using a linear approximation with reference to a radial position of the recording-start position.

6. The information recording method as claimed in claim 4, wherein the recording power adjustment process is carried out only when the recording-start position is located at a radial position greater than a predetermined radial position of the optical recording medium.

7. The information recording method as claimed in claim 1, wherein the recording power adjustment process adjusts the adjustment amount of the recording power according to a kind of the optical recording medium.

8. The information recording method as claimed in claim 1, wherein the recording power adjustment process adjusts the adjustment amount of the recording power with reference to an adjustment amount of the recording power beforehand stored in a non-volatile memory of an information recording apparatus.

9. The information recording method as claimed in claim 1, wherein
the trial writing process performs trial writing on a trial writing area located at an inner circumference and a trial writing area located at an outer circumference of a target recording layer of the optical recording medium, and obtains optimal recording power of each trial writing area, and
the recording power adjustment process adjusts the optimal recording power obtained from the trial writing area of the inner circumference with reference to the optimal recording power obtained from the trial writing area of the outer circumference according to a recording-start position when recording on the target recording layer that should be recorded on from the outer circumference to the inner circumference.

10. The information recording method as claimed in claim 9, wherein the recording power adjustment process carries out linear approximation of the optimal recording power obtained from the trial writing area of the inner circumference and the optimal recording power obtained from the trial writing area of the outer circumference, and obtains the adjustment amount according to the radial position of the recording-start position of the optical-recording medium.

11. The information recording method as claimed in claim 9, wherein the recording power adjustment process is carried out only when the recording-start position is located in an area with a radial position greater than a predetermined radial position of the optical-recording medium, and the optimal recording power is adjusted using a difference between the optimal recording power obtained from the trial writing area of the inner circumference and the optimal recording power obtained from the trial writing area of the outer circumference.

12. The information recording method as claimed in claim 9, wherein:
the trial writing process is performed only on the trial writing area located in the outer circumference of the target recording layer of the optical recording medium, and obtains the optimal recording power, when the recording-start position is at the outermost circumference position; and
the recording power adjustment process starts the recording operation using the optimal recording power obtained at the trial writing process.

13. The information recording method as claimed in claim 1, wherein:
the multilayer optical recording medium is an optical recording medium that has two or more recording layers that are recorded on by an opposite track path (OTP) method based on the DVD+R specifications; and
the trial writing process and the recording power adjustment process are carried out when a target recording layer should be recorded on from the outer circumference to the inner circumference of the optical recording medium.

14. An information recording apparatus, wherein information is recorded by irradiating a laser beam onto a multilayer optical recording medium, comprising:
a trial writing unit for performing trial writing of data on a trial writing area of the optical recording medium with recording power of the laser beam being gradually changed, and obtaining optimal recording power based on a reproduced signal of the data that are trial-written in advance of a recording operation start; and
a recording power adjustment unit for adjusting the optimal recording power according to a recording-start position, and starting the recording operation using the adjusted optimal recording power.

15. The information recording apparatus as claimed in claim 14, wherein
the trial writing area on which the trial writing unit performs trial writing is located at an inner circumference of a target recording layer of the optical recording medium, and
the recording power adjustment unit adjusts the optimal recording power according to the recording-start position when recording on the target recording layer that should be recorded on from an outer circumference to the inner circumference.

16. The information recording apparatus as claimed in claim 15, further comprising:
a running trial writing unit for obtaining the optimal recording power based on the reproduced signal of the data that are trial-written during the recording operation, wherein
the recording power adjustment unit adjusts the recording power after starting the recording operation to the optimal recording power obtained by the running trial writing unit.

17. The information recording apparatus as claimed in claim 15, wherein the recording power adjustment unit adjusts the adjustment amount according to the recording-start position.

18. The information recording apparatus as claimed in claim 17, wherein the recording power adjustment unit adjusts the adjustment amount using a linear approximation with reference to a radial position of the recording-start position.

19. The information recording apparatus as claimed in claim 17, wherein the recording power adjustment unit adjusts the recording power only when the recording-start position is located at a radial position greater than a predetermined radial position of the optical recording medium.

20. The information recording apparatus as claimed in claim 14, wherein the recording power adjustment unit adjusts the adjustment amount of the recording power according to a kind of the optical recording medium.

21. The information recording apparatus as claimed in claim 14, wherein the recording power adjustment unit adjusts the adjustment amount of the recording power with reference to an adjustment amount of the recording power beforehand stored in a non-volatile memory of the information recording apparatus.

22. The information recording apparatus as claimed in claim 14, wherein
the trial writing unit performs trial writing on a trial writing area located at an inner circumference and a trial writing area located at an outer circumference of a target recording layer of the optical recording medium, and obtains optimal recording power of each trial writing area, and
the recording power adjustment unit adjusts the optimal recording power obtained from the trial writing area of the inner circumference with reference to the optimal recording power obtained from the trial writing area of the outer circumference according to a recording-start position when recording on the target recording layer that should be recorded on from the outer circumference to the inner circumference.

23. The information recording apparatus as claimed in claim 22, wherein the recording power adjustment unit carries out linear approximation of the optimal recording power obtained from the trial writing area of the inner circumference and the optimal recording power obtained from the trial writing area of the outer circumference, and obtains the adjustment amount according to the radial position of the recording-start position of the optical-recording medium.

24. The information recording apparatus as claimed in claim 22, wherein the recording power adjustment unit carries out recording power adjustment only when the recording-start position is located in an area with a radial position greater than a predetermined radial position of the optical-recording medium, and the optimal recording power is adjusted using a difference between the optimal recording power obtained from the trial writing area of the inner circumference and the optimal recording power obtained from the trial writing area of the outer circumference.

25. The information recording apparatus as claimed in claim 22, wherein:
the trial writing unit performs trial writing only on the trial writing area located in the outer circumference of the target recording layer of the optical recording medium, and obtains the optimal recording power, when the recording-start position is at the outermost circumference position; and
the recording power adjustment unit starts the recording operation using the optimal recording power obtained by the trial writing unit.

26. The information recording apparatus as claimed in claim 14, wherein:
the multilayer optical recording medium is an optical recording medium that has two or more recording layers that are recorded on by an opposite track path (OTP) method based on the DVD+R specifications; and
the trial writing unit and the recording power adjustment unit carry out respective functions when a target recording layer should be recorded on from the outer circumference to the inner circumference of the optical recording medium.
